(19) United States
(12) Patent Application Publication
(10) Pub. No.: US 2023/0012850 A1
(43) Pub. Date: Jan. 19, 2023

(54) CONTROL DEVICE, DISASTER SUPPORT SYSTEM, AND STORAGE MEDIUM

(71) Applicant: TOYOTA JIDOSHA KABUSHIKI KAISHA, Toyota-shi (JP)

(72) Inventors: Yusuke HOKI, Mishima-shi (JP); Koseki SUGIYAMA, Sunto-gun (JP); Kumiko KATSUMATA, Susono-shi (JP); Rie YAYABE, Sunto-gun (JP); Shin SAKURADA, Toyota-shi (JP); Tomio YAMANAKA, Nagoya-shi (JP)

(73) Assignee: TOYOTA JIDOSHA KABUSHIKI KAISHA, Toyota-shi (JP)

(21) Appl. No.: 17/752,998

(22) Filed: May 25, 2022

(30) Foreign Application Priority Data
Jul. 16, 2021 (JP) 2021-118187

(51) Int. Cl. B60L 53/30; B60L 53/14; B60L 53/50; B60L 58/12

(52) U.S. Cl. CPC B60L 53/305; B60L 53/14; B60L 53/50; B60L 58/12; B60L 2250/16; B60L 2250/20

(57) ABSTRACT

An ECU acquires history information on whether there is an experience of external power supply by a vehicle, and the ECU determines whether a user of the vehicle has experienced the external power supply, based on the history information. In a case where the ECU determines that the user has not experienced the external power supply of the vehicle, the ECU outputs recommendation information that recommends the user to experience the external power supply of the vehicle.

### CROSS-REFERENCE TO RELATED APPLICATION

This application claims priority to Japanese Patent Application No. 2021-118187 filed on Jul. 16, 2021, incorporated herein by reference in its entirety.

### BACKGROUND

### 1. Technical Field

This disclosure relates to a control device, a disaster support system, and a storage medium.

### 2. Description of Related Art

Japanese Unexamined Patent Application Publication No. 2019-161687 (JP 2019-161687 A) describes a technology in which an appropriate stop condition to stop external power supply is set in consideration of the state of a vehicle that changes depending on the position of the vehicle at the time of a disaster, thereby preventing a shortage of electric power necessary for the vehicle to travel.

### SUMMARY

In the meantime, JP 2019-161687 A considers only a timing of power supply at the time of a disaster. Accordingly, in a case where a user who owns a vehicle has not experienced external power supply, the user might not know the procedure of a power supply method.

This disclosure is accomplished in view of the above problem, and an object of this disclosure is to provide a control device, a disaster support system, and a storage medium each of which can promote a user who owns a vehicle to experience external power supply.

A control device according to this disclosure includes a processor configured to execute the followings: acquiring history information on whether there is an experience of external power supply by a vehicle; determining whether a user of the vehicle has experienced the external power supply, based on the history information; and in a case where the processor determines that the user has not experienced the external power supply, outputting recommendation information that recommends the user to experience the external power supply.

Further, a disaster support system according to this disclosure includes a vehicle, a communications device, and a control device. The vehicle includes a display portion on which an image or a text is displayable. The communications device is associated with the vehicle and communicable with the vehicle. The control device includes a processor configured to execute the followings: acquiring history information on whether there is an experience of external power supply by the vehicle; determining whether a user of the vehicle has experienced the external power supply, based on the history information; and in a case where the processor determines that the user has not experienced the external power supply, outputting recommendation information that recommends the user to experience the external power supply.

Further, a storage medium according to this disclosure is a storage medium storing a program causing a control device to execute the followings: acquiring history information on whether there is an experience of external power supply by a vehicle;

determining whether a user of the vehicle has experienced the external power supply, based on the history information; and in a case where the processor determines that the user has not experienced the external power supply, outputting recommendation information that recommends the user to experience the external power supply.

With this disclosure, it is possible to yield an effect that a user who owns a vehicle can experience external power supply.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a view illustrating a schematic configuration of a disaster support system according to Embodiment 1;

FIG. 2 is a block diagram illustrating a functional configuration of a vehicle according to Embodiment 1;

FIG. 3 is a flowchart illustrating the outline of a process to be executed by the vehicle according to Embodiment 1;

FIG. 4 is a view illustrating one example of recommendation information to be displayed on a display portion included in the vehicle according to Embodiment 1;

FIG. 5 is a view illustrating one example of preparation information to be displayed on the display portion included in the vehicle according to Embodiment 1;

FIG. 6 is a view illustrating one example of a message indicative of the procedure of a usage method of a portable power supply apparatus to be displayed on the display portion included in the vehicle according to Embodiment 1;

FIG. 7 is a view illustrating one example of a message indicative of the procedure of the usage method of the portable power supply apparatus to be displayed on the display portion included in the vehicle according to Embodiment 1;

FIG. 8 is a view illustrating one example of a message indicative of the procedure of the usage method of the portable power supply apparatus to be displayed on the display portion included in the vehicle according to Embodiment 1;

FIG. 9 is a view illustrating a schematic configuration of a disaster support system according to Embodiment 2;

FIG. 10 is a block diagram illustrating a functional configuration of a support server according to Embodiment 2; and

FIG. 11 is a flowchart illustrating the outline of a process to be executed by the support server according to Embodiment 2.

### DETAILED DESCRIPTION OF EMBODIMENTS

The following describes a control device, a disaster support system, and a program according to embodiments of this disclosure with reference to the drawings. Note that this disclosure is not limited to the following embodiments. Further, in the following description, the same element has the same reference sign.

Embodiment 1

Schematic Configuration of Disaster Support System

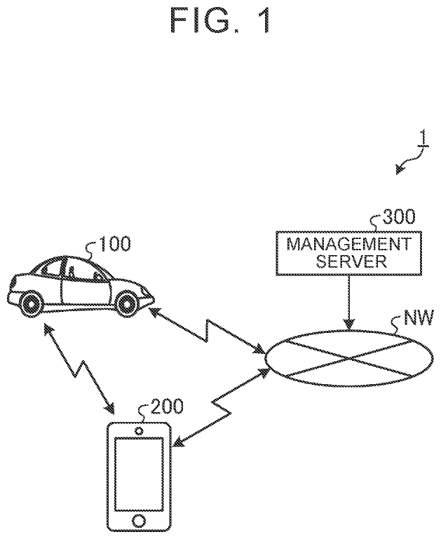

FIG. 1 is a view illustrating a schematic configuration of a disaster support system according to Embodiment 1. A disaster support system 1 illustrated in FIG. 1 includes a vehicle 100, a communications device 200 associated with the vehicle 100, and a management server 300 communicable with the vehicle 100 and the communications device 200 via a network NW. The network NW is constituted by an Internet network, a mobile phone network, or the like, for example.

The vehicle 100 is achieved by use of any of a hybrid electric vehicle (HEV), a plug-in hybrid electric vehicle (PHEV), a fuel cell electric vehicle (FCEV), and a battery electric vehicle (BEV). Note that a detailed configuration of the vehicle 100 will be described later.

The communications device 200 can communicate with the vehicle 100 in accordance with a predetermined communications standard and can communicate with the management server 300 via the network NW. Here, the predetermined communications standard is at least either one of Bluetooth (registered trademark) and Wi-Fi (registered trademark). The communications device 200 is constituted by use of a mobile phone, a tablet-type communication terminal, or the like, for example.

The management server 300 manages a plurality of different payment methods associated with the communications device 200 via the network NW, the different payment methods being managed by respective companies and registered in a digital wallet dealing with a deposit-withdrawal account for electronic money or points.

Functional Configuration of Vehicle

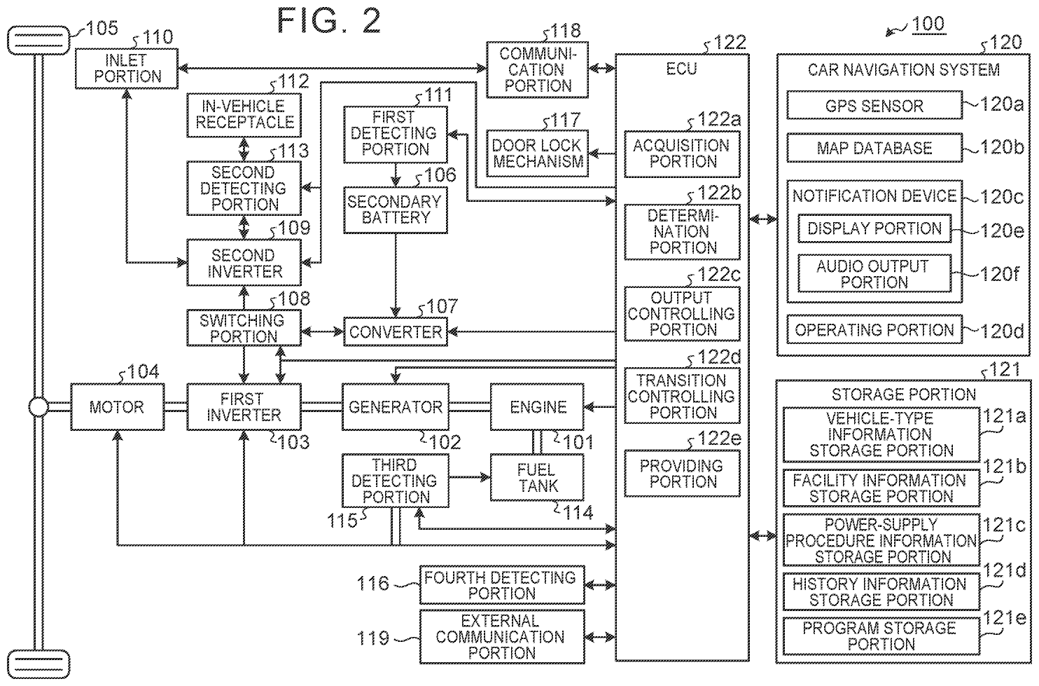

Next will be described a detailed functional configuration of the vehicle 100. FIG. 2 is a block diagram illustrating the functional configuration of the vehicle 100. As illustrated in FIG. 2, the vehicle 100 includes an engine 101, a generator 102, a first inverter 103, a motor 104, driving wheels 105, a secondary battery 106, a converter 107, a switching portion 108, a second inverter 109, an inlet portion 110, a first detecting portion 111, an in-vehicle receptacle 112, a second detecting portion 113, a fuel tank 114, a third detecting portion 115, a fourth detecting portion 116, a door lock mechanism 117, a communication portion 118, an external communication portion 119, a car navigation system 120, a storage portion 121, and an electronic control unit (ECU) 122.

The engine 101 is constituted by a well-known internal combustion engine and outputs power by use of fuel accumulated in the fuel tank 114. The engine 101 is driven under the control of the ECU 122. The power output from the engine 101 drives the generator 102.

The generator 102 is electrically connected to the motor 104 via the first inverter 103. The generator 102 supplies generated alternating current power to the secondary battery 106 via the switching portion 108 and the converter 107 under the control of the ECU 122. The generator 102 is constituted by a power-generation motor generator having a motor function in addition to a power generation function.

The first inverter 103 converts discharge electric power (direct current power) supplied from the secondary battery 106 via the switching portion 108 and the converter 107 into alternating current power and supplies the alternating current power to the motor 104, under the control of the ECU 122. Further, the first inverter 103 converts alternating current power generated by the motor 104 to direct current power at the time of regenerative braking of the vehicle 100 and supplies the direct current power to the secondary battery 106 via the switching portion 108 and the converter 107 under the control of the ECU 122. The first inverter 103 is constituted by, for example, a three-phase inverter circuit or the like including a bridge circuit including a three-phase switching element.

The motor 104 is driven by alternating current power supplied from the first inverter 103 at the time of acceleration of the vehicle 100, under the control of the ECU 122. The power output from the motor 104 drives the driving wheels 105. Further, the motor 104 functions as a generator configured to generate electric power by external force transmitted from the driving wheels 105 at the time of braking of the vehicle 100 under the control of the ECU 122 and supplies the electric power thus generated to the secondary battery 106 from the first inverter 103 via the switching portion 108 and the converter 107. The motor 104 is constituted by a driving motor generator having a power generation function in addition to a motor function.

The secondary battery 106 is constituted by a chargeable-dischargeable storage battery such as a nickel-metal hydride battery or a lithium ion battery, or a storage element such as an electric double layer capacitor, for example. The secondary battery 106 can be charged and discharged by the converter 107, and high-voltage direct current power is stored in the secondary battery 106.

A first end of the converter 107 is electrically connected to the secondary battery 106, and a second end of the converter 107 is electrically connected to either one of the first inverter 103 and the second inverter 109 via the switching portion 108. The converter 107 charges and discharges the secondary battery 106 under the control of the ECU 122. More specifically, in a case where the converter 107 charges the secondary battery 106, the converter 107 decreases the voltage of direct current power externally supplied via the second inverter 109, the inlet portion 110, and the switching portion 108 to a predetermined voltage and supplies, to the secondary battery 106, a resultant charge current with the decreased voltage. In the meantime, in a case where the converter 107 discharges the secondary battery 106, the converter 107 increases the voltage of direct current power from the secondary battery 106 and supplies a resultant discharge current with the increased voltage to the first inverter 103 via the switching portion 108.

A first end of the switching portion 108 is electrically connected to the converter 107, and a second end of the switching portion 108 is electrically connected to either one of the first inverter 103 and the second inverter 109. The switching portion 108 electrically connects the converter 107 to either one of the first inverter 103 and the second inverter 109 under the control of the ECU 122. The switching portion 108 is constituted by a mechanical relay, a semiconductor switch, or the like.

A first end of the second inverter 109 is electrically connected to the switching portion 108, and a second end of the second inverter 109 is electrically connected to the inlet portion 110 or the in-vehicle receptacle 112. The second inverter 109 converts discharge electric power (direct current power) supplied from the secondary battery 106 via the switching portion 108 and the converter 107 into alternating current power and supplies the alternating current power to the inlet portion 110 under the control of the ECU 122. More specifically, the second inverter 109 supplies alternating current power to outside via the inlet portion 110 and a charge-discharge wire (not illustrated) under the control of the ECU 122. The second inverter 109 is constituted by a single-phase inverter circuit or the like so as to correspond to the type of electric power to be used outside.

A first end of the inlet portion 110 is electrically connected to the second inverter 109. The charge-discharge wire (not illustrated) is detachably connected to the inlet portion 110. The inlet portion 110 supplies alternating current power supplied from outside to the second inverter 109 via the charge-discharge wire and outputs various pieces of information including a control signal or the like input from outside to the communication portion 118. Further, the inlet portion 110 supplies alternating current power supplied from the second inverter 109 to outside via the charge-discharge wire and outputs, to outside, various pieces of information including a control signal input from the ECU 122 or the like via the communication portion 118.

The first detecting portion 111 detects a state of charge (SOC), a temperature, a state of health (SOH), a voltage value, and a current value of the secondary battery 106 and outputs the detection results to the ECU 122. The first detecting portion 111 is constituted by an ammeter, a voltmeter, a temperature sensor, and so on.

The in-vehicle receptacle 112 is electrically connected to the second inverter 109. A power plug of a general electric appliance is connectable to the in-vehicle receptacle 112, and the in-vehicle receptacle 112 supplies alternating current power supplied from the second inverter 109 to an electric appliance the power plug of which is connected to the in-vehicle receptacle 112.

The second detecting portion 113 is provided between the in-vehicle receptacle 112 and the second inverter 109. The second detecting portion 113 detects at least one of power consumption and a current value of electric equipment connected to the in-vehicle receptacle 112 and outputs the detection result to the ECU 122. The second detecting portion 113 is constituted by a wattmeter, an ammeter, and a voltmeter, and so on.

Fuel to be supplied to the engine 101 is accumulated in the fuel tank 114. Here, the fuel is fossil fuel such as gasoline. Note that, in a case where the vehicle 100 is an FCEV, hydrogen fuel is accumulated in the fuel tank 114.

The third detecting portion 115 detects a residual amount of the fuel accumulated in the fuel tank 114 and outputs the detection result to the ECU 122. The third detecting portion 115 is constituted by a fuel gauge or the like.

The fourth detecting portion 116 detects status information on the vehicle 100 and outputs the detection result to the ECU 122. Here, the status information is an acceleration, an inclination angle, a speed, and so on of the vehicle 100. The fourth detecting portion 116 is constituted by an acceleration sensor, a velocity sensor, a gyro sensor, and so on.

The door lock mechanism 117 opens and closes a door provided in the vehicle 100 under the control of the ECU 122.

The communication portion 118 receives a control signal including various pieces of information input from outside via the inlet portion 110 and outputs the control signal thus received to the ECU 122. Further, the communication portion 118 outputs a control signal including CAN data or the like input from the ECU 122 to the inlet portion 110. The communication portion 118 is constituted by a communications module or the like.

The external communication portion 119 transmits various pieces of information input from the ECU 122 to the communications device 200 in accordance with a predetermined communications standard under the control of the ECU 122. Further, the external communication portion 119 outputs various pieces of information received from the communications device 200 to the ECU 122. Here, the predetermined communications standard is at least one of Wi-Fi (registered trademark) and Bluetooth (registered trademark). The external communication portion 119 is constituted by a wireless communications module or the like.

The car navigation system 120 includes a global positioning system (GPS) sensor 120a, a map database 120b, a notification device 120c, and an operating portion 120d.

The GPS sensor 120a receives signals from a plurality of GPS satellites or transmitting antennas and calculates position information on the position (longitude and latitude) of the vehicle 100 based on the signals thus received. The GPS sensor 120a is constituted by a GPS reception sensor or the like. Note that, in Embodiment 1, a plurality of GPS sensors 120a may be provided to improve direction accuracy of the vehicle 100.

In the map database 120b, various pieces of map information are stored. The map database 120b is constituted by a storage medium such as a hard disk drive (HDD) or a solid state drive (SSD).

The notification device 120c includes a display portion 120e on which an image, a map, a video, and text information are displayed, and an audio output portion 120f configured to output sound such as voice or warning sound. The display portion 120e is constituted by use of a display such as a liquid crystal display or an organic electroluminescence (EL) display. The audio output portion 120f is constituted by a speaker or the like.

The operating portion 120d receives operations input by a user and outputs signals corresponding to various operation contents thus received to the ECU 122. The operating portion 120d is constituted by a touchscreen, a button, a switch, a jog dial, or the like.

The car navigation system 120 configured as such superimposes position information on a present position of the vehicle 100 that is acquired by the GPS sensor 120a on a map corresponding to map data stored in the map database 120b. Hereby, the car navigation system 120 notifies the user of information including a road on which the vehicle 100 is currently traveling, a travel route to a destination, and so on, by use of the display portion 120e and the audio output portion 120f

In the storage portion 121, various pieces of information on the vehicle 100 is stored. In the storage portion 121, CAN data on the vehicle 100 that is input from the ECU 122, various pieces of data under processing by the ECU 122, and so on are stored. The storage portion 121 is constituted by a DRAM, a ROM, a flash memory, an SSD, or the like. The storage portion 121 includes a vehicle-type information storage portion 121a, a facility information storage portion 121b, a power-supply procedure information storage portion 121c, a history information storage portion 121d, and a program storage portion 121e. In the vehicle-type information storage portion 121a, vehicle-type identification information based on which the vehicle 100 is identified, a model year of the vehicle 100, information on whether power generation is performed, information indicative of any of HEV, PHEV, FCEV, and BEV, and so on are stored. In the facility information storage portion 121b, facility information is stored. The facility information includes the address of a facility where a portable power supply apparatus or a charge-discharge apparatus is provided, the name of the facility, the business type of the facility, and so on. In the power-supply procedure information storage portion 121c, power-supply procedure information on the procedure of a power supply method using the portable power supply apparatus or the charge-discharge apparatus is stored. In the history information storage portion 121d, a history such as the number of times of external power supply of the vehicle 100 or whether a user has experienced the external power supply is stored. In the program storage portion 121e, various programs to be executed by the vehicle 100 are stored.

The ECU 122 is constituted by use of a memory and a processor including hardware such as a central processing unit (CPU). The ECU 122 controls operations of constituent portions constituting the vehicle 100. The ECU 122 includes an acquisition portion 122a, a determination portion 122b, an output controlling portion 122c, a transition controlling portion 122d, and a providing portion 122e.

The acquisition portion 122a acquires history information indicative of whether there is an experience of the external power supply by the vehicle 100, from the history information storage portion 121d. Further, the acquisition portion 122a acquires facility information stored in the facility information storage portion 121b.

The determination portion 122b determines whether a user who owns the vehicle 100 has experienced the external power supply, based on the history information acquired by the acquisition portion 122a. Further, the determination portion 122b determines whether the user applies for experience of the external power supply, based on an operation signal input from the operating portion 120d. Further, the determination portion 122b determines whether the user owns a portable power supply apparatus or a charge-discharge apparatus.

The output controlling portion 122c outputs, to the display portion 120e, recommendation information that recommends the user to experience the external power supply. Further, the output controlling portion 122c outputs, to the display portion 120e or the communications device 200, preparation information that promotes the user to prepare for the external power supply by use of the portable power supply apparatus or the charge-discharge apparatus.

The transition controlling portion 122d outputs a usage method of the portable power supply apparatus or the charge-discharge apparatus in the external power supply of the vehicle 100 to the display portion 120e or the communications device 200 in a transition manner. More specifically, in response to a user operation, the transition controlling portion 122d outputs the usage method in the external power supply of the vehicle 100 to the display portion 120e or the communications device 200 in a transition manner.

The providing portion 122e executes a providing process of providing electronic money or points corresponding to the experience of the external power supply of the vehicle 100 to any one of the different payment methods registered by an occupant by use of the communications device 200 in the management server 300 via the network NW and the external communication portion 119. The payment methods are managed by respective companies and registered in a digital wallet server dealing with a deposit-withdrawal account for the electronic money or the points.

Process of Vehicle

Next will be described a process to be executed by the vehicle 100. FIG.

3 is a flowchart illustrating the outline of the process to be executed by the vehicle 100. Note that the following describes a process to be executed when an occupant gets in the vehicle 100.

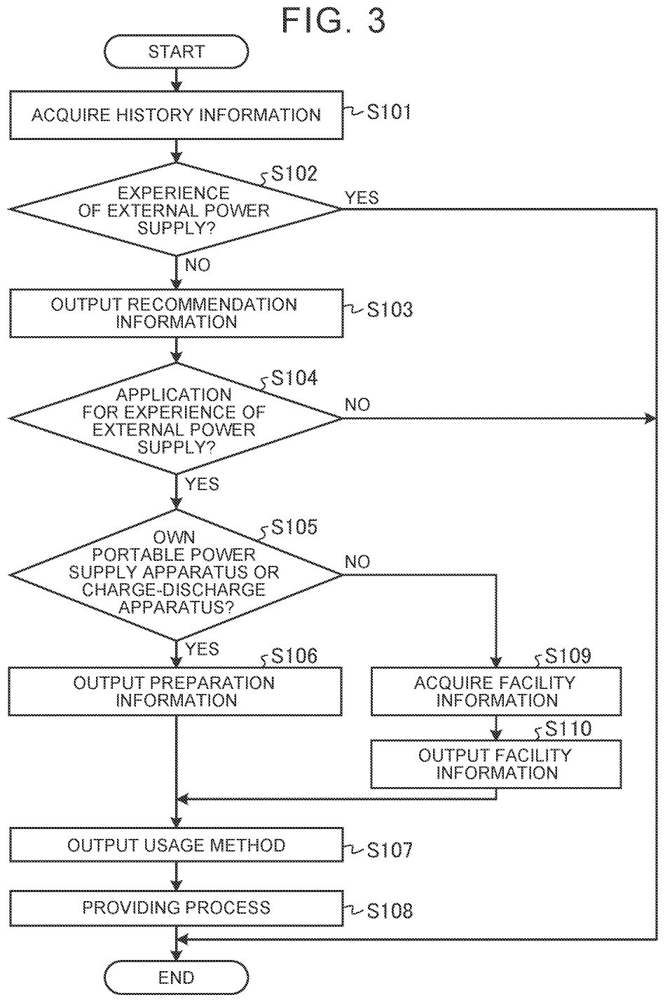

As illustrated in FIG. 3, the acquisition portion 122a acquires history information indicative of whether there is an experience of the external power supply by the vehicle 100, from the history information storage portion 121d (step S101).

Subsequently, the determination portion 122b determines, based on the history information acquired by the acquisition portion 122a, whether a user who owns the vehicle 100 has experienced the external power supply (step S102). In a case where the determination portion 122b determines that the user who owns the vehicle 100 has experienced the external power supply (step S102: Yes), the vehicle 100 ends this process. In the meantime, in a case where the determination portion 122b determines that the user who owns the vehicle 100 has not experienced the external power supply (step S102: No), the vehicle 100 proceeds to step S103 (described below).

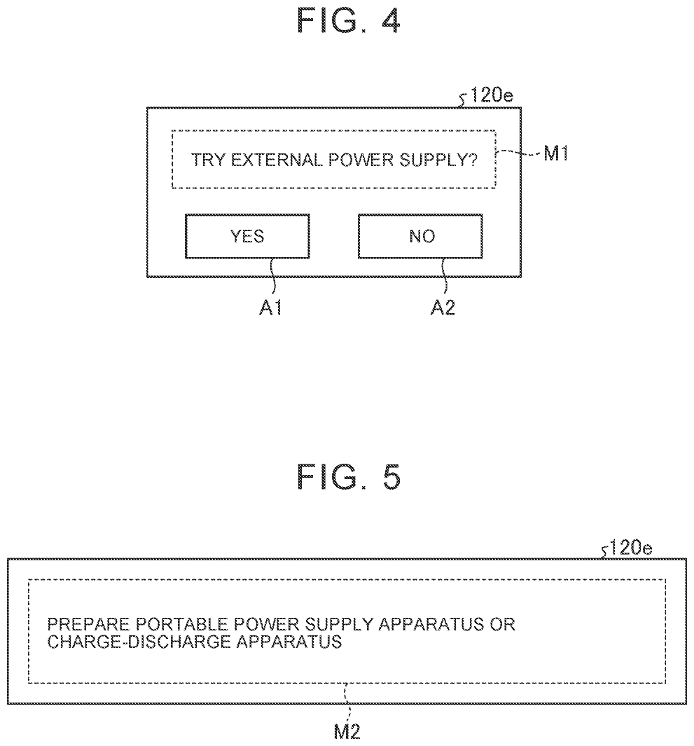

In step S103, the output controlling portion 122c outputs, to the display portion 120e, recommendation information that recommends the user to experience the external power supply. More specifically, as illustrated in FIG. 4, the output controlling portion 122c outputs, to the display portion 120e or the communications device 200, recommendation information including a message M1 that recommends the user to experience the external power supply. Hereby, the user (occupant) who owns the vehicle 100 can grasp that the vehicle 100 has a power supply function, and besides, the user can consciously try to experience the external power supply of the vehicle 100.

Subsequently, the determination portion 122b determines whether the user applies for experience of the external power supply, based on an operation signal input from the operating portion 120d (step S104). More specifically, based on an operation signal input from the operating portion 120d, the determination portion 122b determines which one of an icon A1 or an icon A2 of the recommendation information displayed on the display portion 120e illustrated in FIG. 4 is selected by the user. In a case where the user selects the icon Al, the determination portion 122b determines that the user applies for experience of the external power supply. In a case where the user selects the icon A2, the determination portion 122b determines that the user does not apply for experience of external power supply. In a case where the determination portion 122b determines that the user applies for experience of the external power supply (step S104: Yes), the vehicle 100 shifts to step S105 (described later). In the meantime, in a case where the determination portion 122b determines that the user does not apply for experience of the external power supply (step S104: No), the vehicle 100 ends this process.

In step S105, the determination portion 122b determines whether the user owns a portable power supply apparatus or a charge-discharge apparatus. For example, the determination portion 122b determines whether a portable power supply apparatus is accommodated in a trunk of the vehicle 100, based on vehicle-type information stored in the vehicle-type information storage portion 121a. In a case where the determination portion 122b determines that the user owns a portable power supply apparatus or a charge-discharge apparatus (step S105: Yes), the vehicle 100 shifts to step S106 (described later). In the meantime, in a case where the determination portion 122b determines that the user does not own a portable power supply apparatus or a charge-discharge apparatus (step S105: No), the vehicle 100 shifts to step S109 (described later).

In step S106, the output controlling portion 122c outputs, to the display portion 120e or the communications device 200, preparation information that promotes the user to prepare for the external power supply by use of the portable power supply apparatus or the charge-discharge apparatus. More specifically, as illustrated in FIG. 5, the output controlling portion 122c outputs, to the display portion 120e or the communications device 200, preparation information including a message M2 that promotes preparation for the external power supply by use of the portable power supply apparatus or the charge-discharge apparatus.

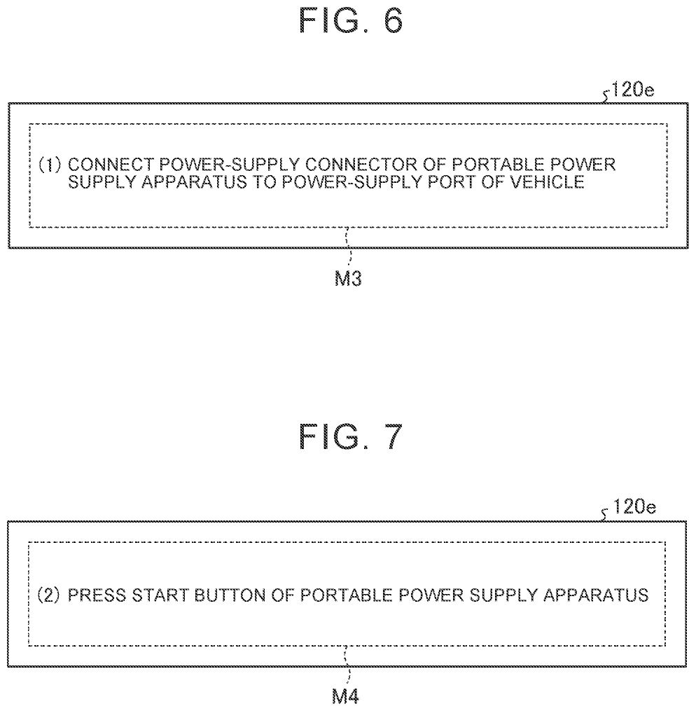

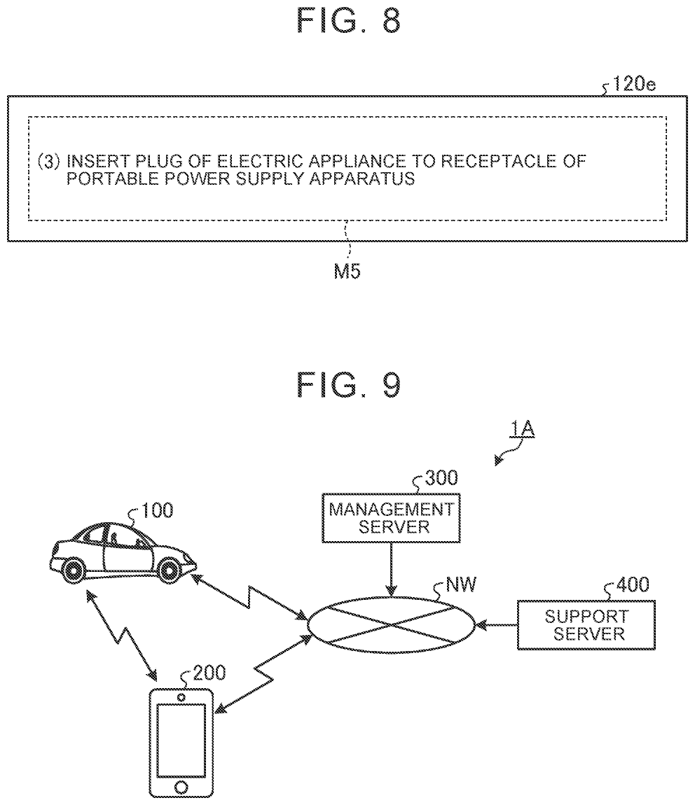

Subsequently, the output controlling portion 122c outputs, to the display portion 120e or the communications device 200, the usage method of the portable power supply apparatus or the charge-discharge apparatus in the external power supply of the vehicle 100 (step S107). In this case, as illustrated in FIGS. 6 to 8, the transition controlling portion 122d outputs, to the display portion 120e or the communications device 200, messages M3, M4, M5 indicative of the procedure of the usage method in the external power supply of the vehicle 100 in a transition manner in accordance with the operation of the user (FIG. 6 FIG. 7 FIG. 8). Hereby, the user of the vehicle 100 can perform the external power supply of the vehicle 100 while the user checks a message displayed on the display portion 120e. As a result, the user can easily experience the external power supply of the vehicle 100.

In step S108, the providing portion 122e executes the providing process of providing electronic money or points corresponding to the experience of the external power supply of the vehicle 100 to any one of the different payment methods registered by the occupant by use of the communications device 200 in the management server 300 via the network NW and the external communication portion 119. The payment methods are managed by respective companies and registered in the digital wallet server dealing with the deposit-withdrawal account for the electronic money or the points. In this case, the providing portion 122e acquires history information on the user from the history information storage portion 121d of the vehicle 100, and based on the acquired history information, the providing portion 122e determines whether the user has experienced the external power supply of the vehicle 100. In a case where the user has experienced the external power supply of the vehicle 100, the providing portion 122e executes the providing process of providing electronic money or points corresponding to the experience of the external power supply of the vehicle 100. Hereby, the user can obtain the electronic money or points by experiencing the external power supply of the vehicle 100. After step S108, the vehicle 100 ends this process.

In step S109, the acquisition portion 122a acquires facility information stored in the facility information storage portion 121b.

Subsequently, the output controlling portion 122c outputs the facility information acquired by the acquisition portion 122a to the display portion 120e (step S110). For example, as illustrated in FIG. 9, the output controlling portion 122c outputs, to the display portion 120e or the communications device 200, the facility information including positional information such as a facility name or an address of a facility where a portable power supply apparatus or a charge-discharge apparatus is provided. Hereby, the user can grasp the facility where the portable power supply apparatus or the charge-discharge apparatus is provided, and the user can experience the external power supply of the vehicle 100 in the facility where the portable power supply apparatus or the charge-discharge apparatus is provided. After step S110, the vehicle 100 shifts to step S107.

In Embodiment 1 described above, in a case where the determination portion 122b determines that the user who owns the vehicle 100 has not experienced the external power supply of the vehicle 100, the output controlling portion 122c outputs recommendation information that recommends the user to experience the external power supply of the vehicle 100, to the display portion 120e or the communications device 200. Hereby, the user who owns the vehicle 100 is promoted to experience the external power supply.

Further, in Embodiment 1, in a case where the determination portion 122b determines that the user has not experienced the external power supply of the vehicle 100, and the determination portion 122b also determines that the user owns either the portable power supply apparatus or the charge-discharge apparatus, the output controlling portion 122c outputs preparation information that promotes preparation of the portable power supply apparatus or the charge-discharge apparatus. In the meantime, in a case where the determination portion 122b determines that the user has not experienced the external power supply of the vehicle 100, and the determination portion 122b also determines that the user does not own either the portable power supply apparatus or the charge-discharge apparatus, the output controlling portion 122c outputs facility information on the facility where the portable power supply apparatus or the charge-discharge apparatus is provided. Hereby, the user who owns the vehicle 100 can experience the external power supply of the vehicle 100.

Further, in Embodiment 1, the transition controlling portion 122d outputs, to the display portion 120e or the communications device 200, the usage method of the portable power supply apparatus or the charge-discharge apparatus in a transition manner. Even in a case where the user does not know the usage method in the external power supply of the vehicle 100, the user can easily perform the external power supply of the vehicle 100.

Further, in Embodiment 1, in a case where the determination portion 122b determines that the user has experienced the external power supply of the vehicle 100, the providing portion 122e executes the providing process of providing electronic money or points corresponding to the experience of the external power supply of the vehicle 100 to any one of the different payment methods that corresponds to the communications device 200 associated with the vehicle 100. The payment methods are managed by respective companies and registered in a digital wallet dealing with the deposit-withdrawal account for the electronic money or the points. Hereby, the user can obtain the electronic money or points in addition to the experience of the external power supply of the vehicle 100.

### Embodiment 2

Next will be described Embodiment 2. In Embodiment 1, the ECU 122 of the vehicle 100 promotes the user to experience the external power supply depending on whether the user who owns the vehicle 100 has experienced the external power supply. In Embodiment 2, the management server promotes the user who owns the vehicle 100 to experience the external power supply via the network NW. The following describes a disaster support system according to Embodiment 2. Note that the same constituent as the disaster support system 1 in Embodiment 1 has the same reference sign as in Embodiment 1, and its description is omitted.

Configuration of Disaster Support System

FIG. 9 is a view illustrating a schematic configuration of a disaster support system according to Embodiment 2. A disaster support system 1A illustrated in FIG. 9 further includes a support server 400 communicable with the vehicle 100, the communications device 200, and the management server 300 via the network NW, in addition to the configuration of the disaster support system 1 according to Embodiment 1.

Functional Configuration of Support Server

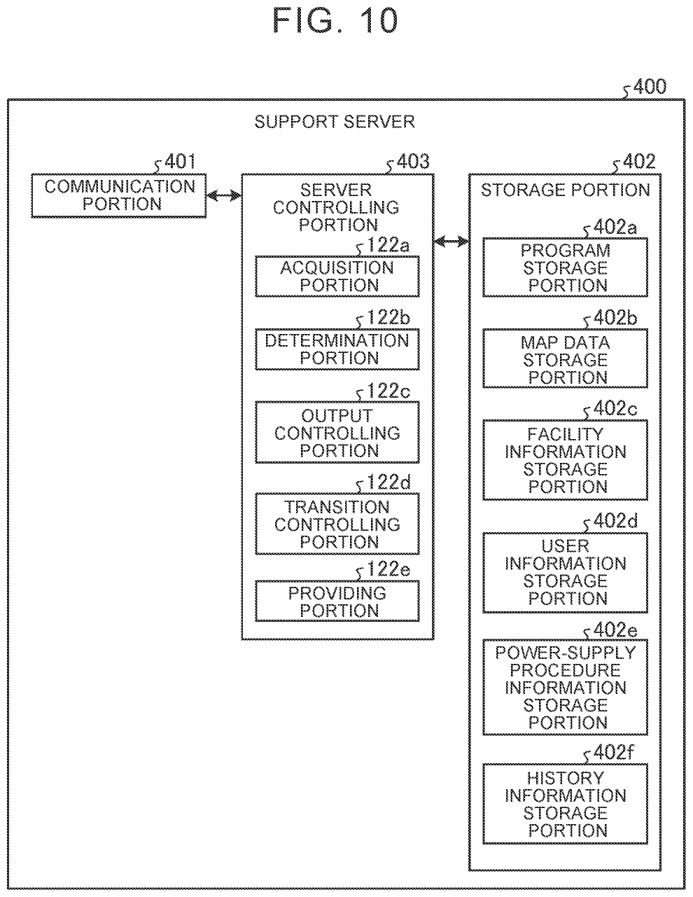

Next will be described a functional configuration of the support server 400. FIG. 10 is a block diagram illustrating the functional configuration of the support server 400. The support server 400 illustrated in FIG. 10 includes a communication portion 401, a storage portion 402, and a server controlling portion 403.

The communication portion 401 receives various pieces of information from the vehicle 100 or the communications device 200 via the network NW and also transmits various pieces of information to the vehicle 100 or the communications device 200 via the network NW, under the control of the server controlling portion 403. The communication portion 401 is constituted by a communications module or the like that can transmit and receive various pieces of information.

In the storage portion 402, various pieces of information on the support server 400 are stored. The storage portion 402 includes a program storage portion 402a in which various programs to be executed by the support server 400 are stored, a map data storage portion 402b in which map data is stored, a facility information storage portion 402c in which facility information on a facility where a portable power supply apparatus or a charge-discharge apparatus is provided, a user information storage portion 402d in which user information on the user who owns the vehicle 100 is stored, a power-supply procedure information storage portion 402e in which power-supply procedure information on the procedure of a power supply method using the portable power supply apparatus or the charge-discharge apparatus is stored, and a history information storage portion 402f in which the history of external power supply of the vehicle 100 is stored. The storage portion 402 is constituted by a DRAM, a ROM, a flash memory, an HDD, an SSD, or the like.

The server controlling portion 403 controls constituent portions constituting the support server 400. The server controlling portion 403 is constituted by a memory and a processor including hardware such as a CPU. The server controlling portion 403 has functions similar to those of the ECU 122. More specifically, the server controlling portion 403 includes the acquisition portion 122a, the determination portion 122b, the output controlling portion 122c, the transition controlling portion 122d, and the providing portion 122e.

Process of Support Server

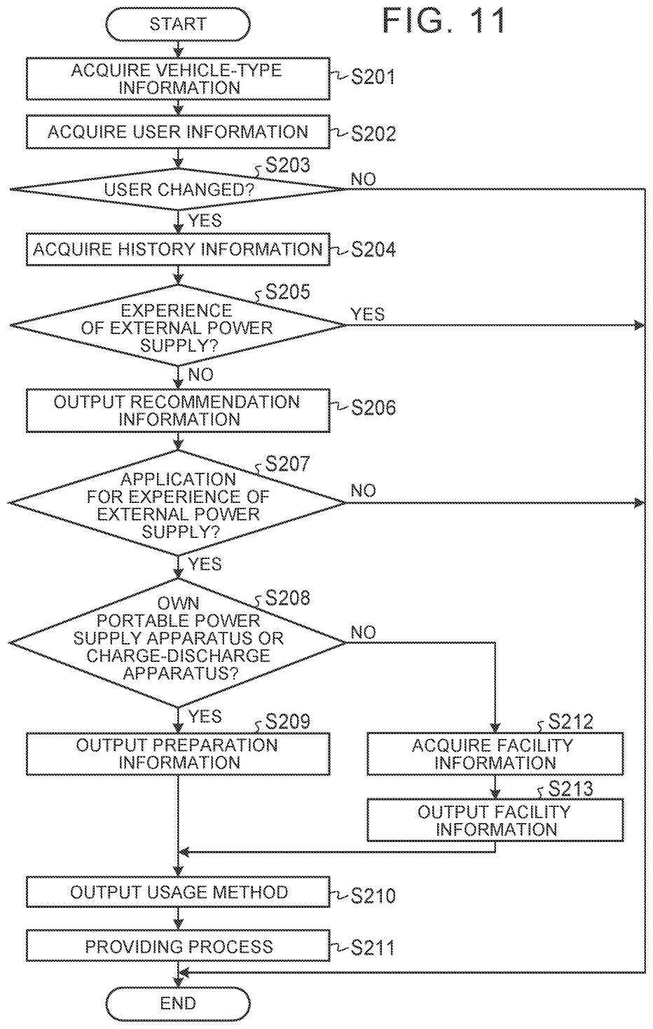

Next will be described a process to be executed by the support server 400. FIG. 11 is a flowchart illustrating the outline of the process to be executed by the support server 400.

As illustrated in FIG. 11, the acquisition portion 122a acquires vehicle-type information from the vehicle 100 via the network NW and the communication portion 401 (step S201) and acquires user information from the user information storage portion 402d (step S202).

Subsequently, the determination portion 122b determines whether the user who owns the vehicle 100 is changed, based on vehicle identification information included in the vehicle-type information acquired by the acquisition portion 122a from the vehicle 100 and the user information acquired from the user information storage portion 402d (step S203). In a case where the determination portion 122b determines that the user who owns the vehicle 100 is changed (step S203: Yes), the support server 400 shifts to step S204 (described later). In the meantime, in a case where the determination portion 122b determines that the user who owns the vehicle 100 is not changed (step S203: No), the support server 400 ends this process.

Step S204 to step S213 correspond to step S101 to step S110 in FIG. 3, respectively. After step S211, the support server 400 ends this process.

In Embodiment 2 described above, the server controlling portion 403 determines whether the user who owns the vehicle 100 is changed, based on the vehicle identification information and the user information, and in a case where the server controlling portion 403 determines that the user who owns the vehicle 100 is changed, the output controlling portion 122c outputs recommendation information that recommends the user to experience the external power supply of the vehicle 100 to the display portion 120e or the communications device 200. Hereby, in a case where the user who owns the vehicle 100 is changed to a new user, when the new user has not experienced the external power supply of the vehicle 100, it is possible to promote the user to experience the external power supply of the vehicle 100.

### Other Embodiments

Further, in Embodiment 1, 2, the “portion” mentioned above can be regarded as a “circuit” or the like. For example, the server controlling portion can be regarded as a server control circuit.

Further, a program to be executed by the disaster support system according to Embodiment 1, 2 is provided by being recorded in a recording medium (storage medium) readable by a computer, e.g., a CD-ROM, a flexible disk (FD), a CD-R, a digital versatile disk (DVD), a USB medium, or a flash memory, as file data in an installable or executable manner.

Further, the program to be executed by the disaster support system according to Embodiment 1, 2 may be stored in a computer connected to a network such as the Internet and may be provided by downloading via the network.

Note that, in the description about the flowcharts in the present specification, the context of processes of steps is exhibited by use of expressions such as “first,” “after that,” and “subsequently.” However, the order of processes necessary to carry out the embodiments is not determined uniquely by those expressions. That is, the order of the processes in the flowcharts described in the present specifications can be changed within a consistent range.

Further effects and modifications can be easily derived by a person skilled in the art. A wider variety of aspects of the disclosure are not limited to specific details and representative embodiments expressed and described above. Accordingly, various changes can be made without departing from the spirit or scope of a general concept of the disclosure defined by attached claims and their equivalents.

What is claimed is:

1. A control device comprising a processor configured to execute the followings:
acquiring history information on whether there is an experience of external power supply by a vehicle;
determining whether a user of the vehicle has experienced the external power supply, based on the history information; and
in a case where the processor determines that the user has not experienced the external power supply, outputting recommendation information that recommends the user to experience the external power supply.

2. The control device according to claim 1, wherein:
the processor determines whether the user owns either of a portable power supply apparatus and a charge-discharge apparatus;
in a case where the processor determines that the user has not experienced the external power supply, when the processor determines that the user owns the either of the portable power supply apparatus and the charge-discharge apparatus, the processor outputs preparation information that promotes preparation of the either of the portable power supply apparatus and the charge-discharge apparatus; and
in a case where the processor determines that the user has not experienced the external power supply, when the processor determines that the user does not own the either of the portable power supply apparatus and the charge-discharge apparatus, the processor outputs facility information on a facility where the portable power supply apparatus or the charge-discharge apparatus is provided.

3. The control device according to claim 2, wherein the processor outputs a usage method of the either of the portable power supply apparatus and the charge-discharge apparatus in a transition manner.

4. The control device according to claim 1, wherein:
the processor determines whether the user has experienced the external power supply; and
in a case where the processor determines that the user has experienced the external power supply, the processor executes a providing process of providing electronic money or points corresponding to the experience of the external power supply to any one of a plurality of different payment methods that corresponds to a communications device associated with the vehicle, the payment methods being managed by respective companies and registered in a digital wallet dealing with a deposit-withdrawal account for the electronic money or the points.

5. The control device according to claim 1, wherein:
the processor acquires vehicle identification information based on which the vehicle is identified and user information on a user corresponding to the vehicle identification information;
the processor determines whether a user who owns the vehicle is changed, based on the vehicle identification information and the user information; and
in a case where the processor determines that the user who owns the vehicle is changed, the processor outputs the recommendation information.

6. A disaster support system comprising:
a vehicle including a display portion on which an image or a text is displayable;
a communications device associated with the vehicle and communicable with the vehicle; and
a control device, wherein:
the control device includes a processor configured to execute the followings
acquiring history information on whether there is an experience of external power supply by the vehicle,
determining whether a user of the vehicle has experienced the external power supply, based on the history information, and
in a case where the processor determines that the user has not experienced the external power supply, outputting recommendation information that recommends the user to experience the external power supply.

7. A non-transitory storage medium storing a program causing a control device to execute the followings:
acquiring history information on whether there is an experience of external power supply by a vehicle;
determining whether a user of the vehicle has experienced the external power supply, based on the history information; and
in a case where the processor determines that the user has not experienced the external power supply, outputting recommendation information that recommends the user to experience the external power supply.
